(19) United States
(12) Patent Application Publication
(10) Pub. No.: US 2025/0095978 A1
(43) Pub. Date: Mar. 20, 2025

(54) MULTIPLE INLET APPARATUS FOR ISOTOPE RATIO SPECTROMETRY

(71) Applicant: Thermo Fisher Scientific (Bremen) GmbH, Bremen (DE)

(72) Inventors: Jens Radke, Bremen (DE); Nils Stoebener, Bremen (DE); Nina Albrecht, Bremen (DE); Johannes Schwieters, Bremen (DE); Michael Krummen, Bremen (DE); Issaku Kohl, Bremen (DE); Jens Radke

(73) Assignee: Thermo Fisher Scientific (Bremen) GmbH, Bremen (DE)

(21) Appl. No.: 18/294,436

(22) PCT Filed: Aug. 2, 2022
(86) PCT No.: PCT/EP2022/071734

§ 371 Date: Feb. 1, 2024

(30) Foreign Application Priority Data
Aug. 2, 2021 (GB) 2111107.5

(51) Int. Cl. H01J 49/04; H01J 49/00; H01J 49/24

(52) U.S. Cl. CPC H01J 49/0422; H01J 49/0031; H01J 49/24

(57) ABSTRACT

A method of operating a multiple inlet apparatus for an isotope ratio spectrometer, the multiple inlet apparatus having a first bellows containing a first gas and a second bellows containing a second gas. The compression of the first bellows is adjusted to a first compression value such that a first pressure of the first gas is equal to a target pressure value and the compression of the second bellows is adjusted to a second compression value such that a second pressure of the second gas is equal to the target pressure value. A first compression function is determined, configured to maintain the first pressure at the target pressure value and a second compression function configured to maintain the second pressure at the target pressure value. The first bellows are continuously compressed according to the first compression function and the second bellows are continuously compressed according to the second compression function.

### FIELD OF THE DISCLOSURE

This invention relates to a multiple inlet apparatus for an isotope ratio mass spectrometer and/or an optical spectrometer, and a method of operating such a multiple inlet apparatus.

### BACKGROUND

Isotope-ratio analysis is used to measure the relative abundance of isotopes (isotope ratio) in a sample, which may be solid, liquid or gaseous. It may be used for a wide variety of elements. From each sample, a sample fluid, preferably a sample gas, can be generated by a known process. For instance, isotope ratio analysis may be used for determining the isotope ratios ¹³C/¹²C and/or ¹⁸O/¹⁶O from CO₂, such as in air, for geological assessment. Isotope-ratio analysis is most commonly performed by mass spectrometry (MS) but may also be performed by optical spectrometry.

For optical spectrometry, for example, an isotope ratio is generally determined in a measurement cell of the spectrometer, by measuring two separate spectral absorption lines, typically in the infrared region, one line for each different isotopic species (isotopologue), e.g. an absorption line for ¹²C¹⁶O₂ and another line for ¹³C¹⁶O₂. A convenient absorption line for CO₂ is the line at or about 4.3218 μm. If more lines are available per isotope (e.g. a doublet or triplet) it is possible to measure and use the information from more than one line, e.g. for other gases than CO₂ or in other spectral ranges that might be interesting. The ratio of the intensities of the spectral absorption lines is a measure of the ratio of the abundance of each of the isotopic species (and hence the isotope ratio, e.g. ¹³C/¹²C). The outputs of the spectrometer are thus ratios of different isotopic lines (e.g. R(¹³C)=c(¹³C)/c(¹²C)). The result is referenced against international standards using the established delta notation for isotope ratio reporting (e.g. δ¹³C [‰]).

A general review of isotope ratio mass spectrometry (IRMS) and gas inlet systems can be found in Brenna et al, Mass Spectrometry Reviews, 1997, 16, 227-258.

In IRMS, a sample is normally measured against a standard, that is, one or more references of known isotopic ratio. Preferably, reference fluids and in particular reference gases are used. To allow this, the spectrometer may be equipped with a Dual Inlet (DI) apparatus. Here, a sample gas (e.g. CO₂) is provided from a high vacuum bellows or, alternatively, from a sample preparation device (such as the Kiel IV Carbonate Device marketed by Thermo Fisher Scientific Inc.) via a thin capillary to the inlet of the mass spectrometer. A reference gas of the same chemical composition as the sample is provided via a second thin capillary from a high vacuum bellows. At the inlet of the IRMS, both sample and reference gases are connected to one or more change over valves, allowing for fast switching between the bellows or sample preparation device. Typically, the change over valve connects either a sample or a reference gas to the ion source of the mass spectrometer and, at the same time, guides the respective other gas to a high vacuum pump (to waste). As a result, sample and reference gases will always be consumed at the same rate-either for measurement, or into waste. The administered reference gas allows normalization, by attributing standardized values of isotope ratios to the measured raw isotope ratios of the sample gas (so-called “delta” notation). In some cases, more than one sample and/or reference bellows or preparation devices may be connected to the mass spectrometer,

In an IRMS, the signal from detected ions of a specific mass-to-charge (m/z) ratio (sometimes designated simply as “mass”, assuming that that charge of the ions, z, is 1) increases with partial pressure of the sample in the ion source. The exact relationship between pressure and detected signal is dependent on the specific molecular type of the ion (e.g. N₂ and CO₂ yield different signal intensities for the same pressure). Additionally, measured isotope ratios (i.e. the ratio of the signals from the same molecular species, but different isotopic composition, e.g. ¹³CO₂/¹²CO₂) change with partial pressure in the ion source and hence with overall intensity. It will be understood that, physically, the isotope ratios of the investigated ions will be the same, irrespective of (or independent from) the partial pressure of the sample. It is only the detected signal that changes (IRMS non-linearity). Reference gases have standardized, pressure-independent values of isotope ratios and this information can be used for standardization purposes. However, due to the aforementioned non-linearity, it is mandatory to measure sample and reference gases at the same partial pressure in the ion source.

A conventional DI technique adjusts the pressure of each of the sample bellows and the reference bellows once prior to measurement, by adjusting the bellows compression to a common setpoint. This is done so that the sample and reference gases are measured at the same partial pressure in the ion source. The signal intensity for a specific mass-to-charge ratio of the sample may be measured immediately before the first measurement of the reference gas, and this signal intensity may be used to adjust the reference gas pressure such that the same signal intensity and, hence, source pressure is reached for the reference gas. Alternatively, sample and reference signal intensities may be adjusted to a common, predefined setpoint prior to all measurements, for example to a signal of 10 V. Sample gas pressure and/or reference gas pressure may be only adjustable if a sufficient quantity of pure reference or sample gases can be provided, otherwise the sample gas might be already consumed during the pressure adjustment. Sample preparation devices may not allow for adjusting the sample intensity at all, in which case only the reference signal intensity may be adjusted. Once the pressure adjustment has been achieved, sequential measurements of reference and sample gases are made over short integration times. Comparison of each sample interval with the two reference intervals taken before and after the sample measurement allows correction of any instrumental drift, as well as correction for changes in the measured isotope ratios due to the depletion of the bellows and the resulting reduction of signal intensities. The two reference measurements are used to calculate a hypothetical isotope ratio of the reference at the time of the sample measurement. This technique, known as bracketing, assumes a linear change in the isotope ratio over time. Depletion curves indicating the decrease of the measured signal intensity over time must be precisely the same for the sample and reference gases. This can be achieved by adjusting the capillary crimping, which adjusts the gas flow rate through the capillary for a given pressure and volume inside the bellows or sample preparation device.

GB2520543 describes another mode of operating an IRMS with a Dual Inlet apparatus. Here, the pressure of the sample and reference gases are readjusted in between measurements to compensate for the loss that each has encountered during its measurement. While this readjustment of the beam intensity reduces the impact of non-linearity over the whole sequence of integration intervals and provides better sample utilization, the non-linearity still exists within the single integration intervals.

Long Integration Dual Inlet (LIDI) is another mode of DI measurement in which sample and reference gases are measured once each over a longer uninterrupted period, rather than the bracketing method described above. LIDI allows better sample utilization, especially when a limited sample volume is available.

Performing bracketing is not possible with LIDI. In view of the limited volume of sample available, taking an initial measurement of the sample intensity before a first reference gas measurement would be impractical and potentially impossible due to the high consumption of the associated sample. Without the initial measurement of the sample intensity, a first measurement of the reference gas at the same intensity is not possible, preventing bracketing within LIDI. As a result, LIDI compares each set of sample measurements (that is, one sample run) to one set of reference measurements (one reference run) only, which is measured after the sample measurements are taken. Provided the instrument drift is sufficiently under control, the accuracy of the calibrated measurements is maintained. Change in ambient temperature is typically the most significant cause for instrumental drift. Control of this can often only be achieved with appropriate environmental conditions in the instrument's place of operation (such as a laboratory).

A further issue arises with LIDI systems. As the sample gas is rapidly consumed during the measurement, partial pressure of the sample gas and accordingly its signal intensity decreases over the time of sample measurement. Due to the non-linearity of IRMS, the observed isotope ratios will therefore also change during the course of the measurement. This may be acceptable, as long as the intensities for sample and reference at the beginning of their respective measurements are precisely the same and the change in isotope ratio is the same for both sample and reference gases; that is, the decay of the signal intensities is the same.

To match the sample intensities, the partial pressure of the reference gas may be adjusted to achieve matching of the measured intensity of the sample. However, this prevents the measurement of a reference gas prior to the sample and at matched intensities. To achieve the same decay in signal intensities, the gas flow for sample and reference through the respective capillaries are desirably kept the same. This is effected by closing down the inner diameter of the capillaries by external compression (“crimping”). The procedure to match the gas flow rates in the capillaries is quite laborious and rarely delivers perfect results. The outcome is also dependent on the actual size of the micro-volumes used for sample and reference, causing potential further mismatch between sample and reference intensity decays. As a result of all these issues, the direct application of bracketing to LIDI has not been considered possible.

EP3608941 describes LIDI with the addition of correction for instrument drift, by measuring the reference gas both before and after the sample gas has been measured. This permits the determination of a first and second relationship between isotope ratios and signal intensities. These relationships are then used to estimate a reference isotope ratio for any chosen time within the measurement period for the sample gas and apply this in the same way as for normal DI bracketing.

While this mode (“bracketed LIDI” or “LIDI 2”) allows for good correction of slow instrumental drifts, it still requires measuring the sample and reference over long integration intervals (e.g. 600 s for each gas), making the correction of fast drifts impossible.

Altogether, the DI techniques set out above aim to compensate for non-linearity rather than prevent the non-linearity from occurring.

In certain cases, it may be possible to achieve a constant signal intensity by maintaining constant pressure in a sample reservoir. WO 2015/067812 A1 describes gas flow from a variable volume reservoir into an analyzer. The reservoirs have a variable volume that is assumed to be proportional to the actuating force applied. A constant actuation results in a constant rate of change of volume, and therefore a constant pressure within the reservoir. The constant pressure allows a constant signal intensity. For example, a syringe is described wherein an actuator pushes the plunger of the syringe at a constant speed, which results in a constant rate of change of volume in the syringe and therefore a constant pressure. Similarly, for a bellows type variable volume reservoir, in certain circumstances a constant flow of gas into the analyzer may be achieved by compressing the bellows at a constant speed, for example by application of a constant driving speed to a linear actuator.

This method is appropriate only where the compression rate or actuation rate of the variable volume reservoir is approximately proportional to the rate of change of volume of the reservoir. For example, if bellows are compressed by a small amount or for a short period of time, the compression rate may be approximately proportional to the rate of change of volume. If the bellows are kept within a certain compression range while being compressed (for example, if they are always more than 60% open, or are in some other compression range in which the compression rate is relatively close to being proportional to the rate of change of volume), then this may also improve linearity between compression rate and rate of change of volume for small amounts of compression. However, if the bellows are compressed by a larger amount or over a longer period of time (whether this occurs in a single compression or over multiple compressions), the compression rate may not be proportional to rate of change of volume of the bellows. Similarly, if the bellows are compressed by a small amount but within a certain compression range (for example below 50% open, or in some other compression range in which the compression rate is relatively far from being proportional to the rate of change of volume) the compression rate may not be proportional to rate of change of volume of the bellows.

### SUMMARY OF THE DISCLOSURE

Against this background, there is provided a method of operating a multiple inlet apparatus for an isotope ratio spectrometer, the multiple inlet apparatus having a first bellows containing a first gas and a second bellows containing a second gas. The method comprises adjusting compression of the first bellows to a first compression value such that a first pressure of the first gas is equal to a target pressure value. The method further comprises adjusting compression of the second bellows to a second compression value, such that a second pressure of the second gas is equal to the target pressure value. The method further comprises determining a first compression function configured to maintain the first pressure at the target pressure and a second compression function configured to maintain the second pressure at the target pressure value. The method further comprises continuously compressing the first bellows according to the first compression function until a first measurement of first isotope ratios for the first gas is complete. The method further comprises continuously compressing the second bellows according to the second compression function until a second measurement of second isotope ratios for the second gas is complete.

In this way, the pressures of the first gas and the second gas are held constant during the respective measurements of the first gas and the second gas, meaning that the gas flow into the ion source is constant during the measurements. The beam intensity is therefore constant throughout the measurements, preventing non-linearity in the measurements and allowing for direct comparison between the sample measurement and the reference measurements.

The method may further comprise compressing the first bellows according to the compression function until a third measurement of third isotope ratios for the first gas is complete, wherein the third measurement takes place after the second measurement.

In this way, the first gas may be measured both before and after the second gas, allowing correction for instrument drift.

Measurements of the first gas and the second gas may alternate such that the first gas and the second gas are each measured at least twice.

Advantageously, multiple measurements of each gas may be made, allowing correction for instrument drift. Measurements of the first and second gases may alternate, for example.

The steps of continuously compressing the first bellows and continuously compressing the second bellows may occur simultaneously.

Advantageously, this prevents sudden changes in gas pressure or gas flow that may introduce non-linearity or a risk of fractionation.

The multiple inlet apparatus may comprise at least one valve that directs the first gas and the second gas towards either an ion source or a vacuum.

In this way, the first and second bellows may be continuously compressed during measurement of both the first and second gases by directing the gas being measured towards the ion source while directing the other gas towards the vacuum. This prevents sudden changes in gas pressure or gas flow that may introduce non-linearity or a risk of fractionation.

During the first measurement the first gas may be directed from the first bellows to the ion source and the second gas may be directed from the second bellows to the vacuum, and during the second measurement the first gas may be directed from the first bellows to the vacuum and the second gas may be directed from the second bellows to the ion source.

In this way, continuous gas flow of both the first gas and the second gas may be maintained throughout measurements of each gas. This prevents sudden changes in gas pressure or gas flow that may introduce non-linearity or a risk of fractionation.

The method may further comprise at least one further measurement of the first gas, wherein the first gas is directed from the first bellows to the ion source and the second gas is directed from the second bellows to the vacuum.

In this way, the first gas may be measured both before and after the second gas, allowing correction for instrument drift.

The first bellows and the second bellows may be compressed using stepper motors.

Advantageously, the velocity of the motor is a function of only stepping frequency, which can be precisely tuned. Furthermore when the holding current is applied to the stepper motor, the bellows position is not altered even if force is applied to the bellows (for example by the vacuum inside the bellows).

The first gas and/or second gas may comprise a first gas mixture and a second gas mixture, respectively.

The target pressure may be equal to a first filling pressure of the first bellows or a second filling pressure of the second bellows.

The target pressure may be independent of a first filling pressure of the first bellows or a second filling pressure of the second bellows.

The first compression function and second compression function may comprise an initial compression based on a starting signal intensity of the spectrometer.

The first compression function and the second compression function may be the same.

In this way a faster calibration may be carried out.

More than one isotope ratio of the first gas may be measured using the same first compression function.

Advantageously, this may decrease the time required to measure multiple isotope ratios.

The first compression function and second compression function may be determined during compression of the first bellows and second bellows respectively by measuring the first pressure and the second pressure.

In this way, the compression functions may keep the pressure constant by using real time measurements of pressure.

A pressure transducer may be used to measure the first pressure and the second pressure.

The first compression function and second compression function may be determined during compression of the first bellows and second bellows respectively by measuring pressure in the ion source.

In this way, the compression functions may keep the pressure constant by using real time measurements of pressure.

The first compression function and second compression function may be determined during compression of the first bellows and second bellows respectively by measuring the gas flow into the ion source.

In this way, the compression functions may keep the pressure constant by using real time measurements of gas flow.

The first bellows may be connected to the ion source via a first inlet and the second bellows may be connected to the ion source via a second inlet.

The multiple inlet apparatus may further comprise at least one additional bellows.

In this way, a plurality of gases may be measured and compared against one another.

The at least one additional bellows may be connected to the ion source via at least one additional inlet.

The multiple inlet apparatus may further comprise a first bellows valve configured to close the first bellows and a second bellows valve configured to close the second bellows. During the first measurement the first gas may be directed from the first bellows to the ion source and the second gas may be enclosed within the second bellows by the second. During the second measurement the second gas may be directed from the second bellows to the ion source and the first gas may be enclosed within the first bellows by the first bellows valve.

In this way the bellows are compressed in an alternating way. While the first bellows is being compressed in order to direct the first gas from the first bellows to the ion source, the second bellows is held closed and the second gas is prevented from leaving the second bellows. While the second bellows is being compressed in order to direct the second gas from the second bellows to the ion source, the first bellows is held closed and the first gas is prevented from leaving the first bellows.

There may be provided software for operating a multiple inlet apparatus for an isotope ratio spectrometer, wherein the software is configured to carry out the method operating a multiple inlet apparatus.

There may be provided a multiple inlet apparatus for an isotope ratio mass spectrometer, configured to be operated via the method of operating a multiple inlet apparatus.

The multiple inlet apparatus for an isotope ratio mass spectrometer may comprise a controller configured to carry out the method of operating a multiple inlet apparatus.

There may be provided an isotope ratio mass spectrometer comprising the multiple inlet apparatus.

There is also provided a method of calibrating a first bellows of a multiple inlet apparatus for an isotope ratio spectrometer, the first bellows containing a first gas at a first pressure. The method comprises obtaining a plurality of calibration depletion curves indicating a rate of depletion for the first bellows containing a calibration gas, wherein each of the plurality of calibration depletion curves is associated with one of a plurality of calibration initial conditions. The method further comprises interpolating an estimated depletion curve indicating an estimated rate of depletion of the first bellows using a first initial condition of the first bellows and the plurality of calibration depletion curves. The method further comprises determining a compression function configured to maintain the first gas at the first pressure while the first bellows are compressed, wherein the compression function is determined based on the estimated depletion curve.

In this way, a compression function may be determined such that when the bellows are compressed according to the compression function, the pressure of the gas in the bellows is constant and so the beam intensity in the ion source is constant. Non-linearity of measurements is prevented.

The plurality of calibration initial conditions may comprise a plurality of compression values.

The plurality of calibration depletion curves may comprise a plurality of beam intensities at a plurality of time points.

The plurality of calibration depletion curves may comprise a plurality of beam intensities at a plurality of pressure values.

An initial beam intensity for each calibration depletion curve of the plurality of calibration depletion curves may be the same or similar as for each other calibration depletion curve of the plurality of calibration depletion curves.

In this way, relationship between beam intensity and bellows compression may be determined for a given initial beam intensity.

The step of obtaining the plurality of depletion curves may further comprise determining a plurality of relationships between beam intensity and compression for a plurality of time points.

The first initial condition may comprise a compression value.

The first initial condition may further comprise a beam intensity.

There is also provided a method of operating a multiple inlet apparatus for an isotope ratio spectrometer, the multiple inlet apparatus having a first bellows containing a first gas and a second bellows having a second gas. The method comprises adjusting compression of the first bellows to a first compression value such that a first pressure of the first gas is equal to a target pressure value. The method further comprises adjusting compression of the second bellows to a second compression value, such that a second pressure of the second gas is equal to the target pressure value. The method further comprises calibrating the first bellows according to the method of calibrating a first bellows to determine a first compression function. The method further comprises calibrating the second bellows according to the method of calibrating a first bellows to determine a second compression function. The method further comprises continuously compressing the first bellows according to the first compression function until a first measurement of first isotope ratios for the first gas is complete. The method further comprises continuously compressing the second bellows according to the second compression function until a second measurement of second isotope ratios for the second gas is complete.

In this way, a compression function may be determined such that when the bellows are compressed according to the compression function, the pressure of the gas in the bellows is constant and so the beam intensity in the ion source is constant. Non-linearity of measurements is prevented.

### BRIEF DESCRIPTION OF THE DRAWINGS

A specific embodiment of the disclosure will now be described, by way of example only, with reference to the accompanying drawings in which:

FIG. 1 shows a schematic diagram of a multiple inlet apparatus, specifically a Dual Inlet apparatus, for an isotope ratio spectrometer in accordance with an embodiment of the present disclosure.

FIG. 2 shows a schematic diagram of a multiple inlet apparatus for an isotope ratio spectrometer.

FIG. 3 shows a flow chart illustrating a method of operating a Dual Inlet for an isotope ratio spectrometer in accordance with an embodiment of the present disclosure.

FIG. 4 shows a graph of ratio of beam intensities against time in accordance with an embodiment of the present disclosure.

FIG. 5 shows a graph illustrating decay of beam intensity for bellows at different compressions in accordance with an embodiment of the present disclosure.

FIG. 6 shows a graph of gas pressure against bellows position in accordance with an embodiment of the present disclosure.

FIG. 7 shows calibration depletion curves of bellows in accordance with an embodiment of the present disclosure.

### DETAILED DESCRIPTION

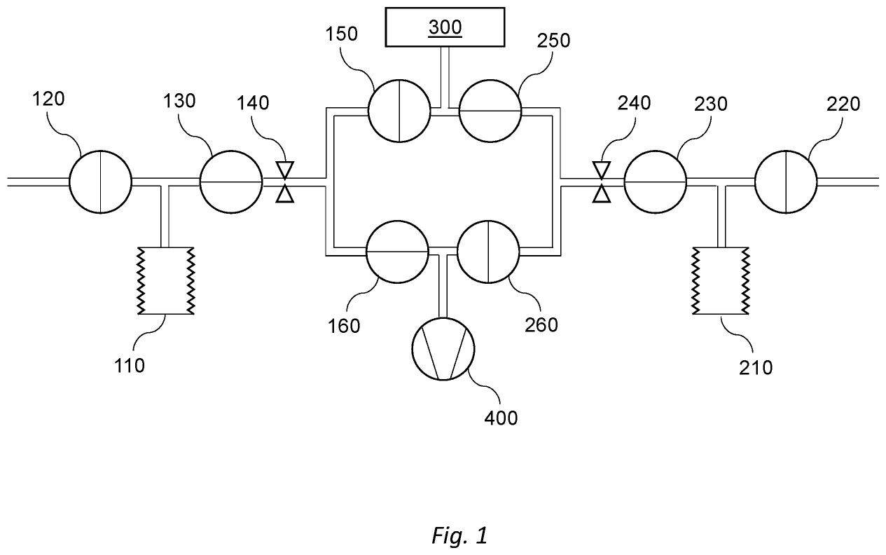

With reference to FIG. 1, a Dual Inlet (DI) apparatus is shown for use in Isotope Ratio Mass Spectrometry (IRMS).

A first gas is provided in a first bellows 110, and may be supplied to the first bellows 110 via a first bellows inlet valve 120 or another direct connection by a gas preparation system. The first bellows 110 may be connected to an ion source or optical detector 300 via thin capillaries, a first bellows outlet valve 130 and a first ion source inlet valve or valve system 150. The first bellows 110 may be connected to a vacuum 400 via thin capillaries, the first bellows outlet valve 130 and a first vacuum inlet valve or valve system 160. The first ion source inlet valve 150 and the first vacuum inlet valve 160 direct the first gas either into the ion source 300 or into a vacuum 400 as waste. A single three-way valve (such as a change-over valve) may be used instead of the first ion source inlet valve 150 and first vacuum inlet valve 160. Alternatively, the first bellows 110 may be connected to the ion source 300 via an orifice. A valve such as a gate valve may open a connection between the first bellows 110 and the ion source 300. The first bellows 110 may be connected to the vacuum 400 via an orifice. A valve such as a gate valve may open a connection between the first bellows 110 and the vacuum 400.

A second gas is provided in a second bellows 210, and may be supplied to the second bellows 210 via a second bellows inlet valve 220 or another direct connection by a gas preparation system. The second bellows 210 may be connected to the ion source or optical detector 300 via thin capillaries, a second bellows outlet valve 230 and a second ion source inlet valve or valve system 250. The second bellows 210 may be connected to the vacuum 400 via thin capillaries, the second bellows outlet valve 230 and a second vacuum inlet valve or valve system 260. The second ion source inlet valve 250 and the second vacuum inlet valve 260 direct the second gas either into the ion source 300 or into a vacuum 400 as waste. A single three-way valve (such as a change-over valve) may be used instead of the second ion source inlet valve 250 and second vacuum inlet valve 260. Alternatively, the second bellows 210 may be connected to the ion source 300 via an orifice. A valve such as a gate valve may open a connection between the second bellows 210 and the ion source 300. The second bellows 210 may be connected to the vacuum 400 via an orifice. A valve such as a gate valve may open a connection between the second bellows 210 and the vacuum 400.

If the first or second gas is non-inert, a high pressure may damage the filament of the ion source. A change over valve system may avoid pressure of the first and second gases being too high before the first and second ion source inlet valves 150 and 250, since the pressure will be levelled to the bellow pressure. Whichever of the first and second gases that is not being directed to the ion source 300 is evacuated to the vacuum 400, so the pressure before the first and second ion source inlet valves 150 and 250 will not exceed the pressure in the bellows. Alternatively, a small orifice could be used to constantly evacuate the bellow gas flow of the gas that is not being directed to the ion source 300.

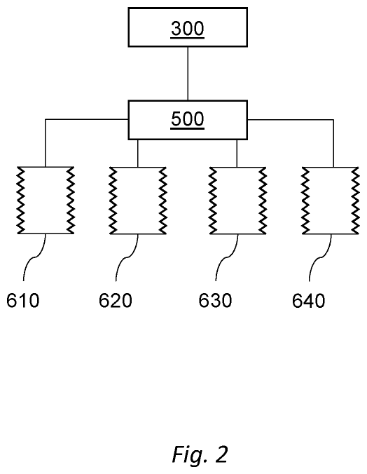

In an embodiment, multiple inlet IRMS may be carried out, wherein three or more gases may be provided in three or more bellows. Each bellows may be connected to the ion source 300 via a multiplied inlet valve system. In an embodiment, a plurality of bellows may be attached to a single changeover valve that directs gas from each bellows towards or away from the ion source. In another embodiment, the plurality of bellows may be attached to a plurality of valves, wherein the plurality of bellows are connected to the ion source 300 via multiple inlets. With reference to FIG. 2, an example is illustrated wherein four bellows 610, 620, 630 and 640 are attached to a change over valve 500 that is configured at any one time to direct gas from one of the bellows 610, 620, 630 and 640 to the ion source 300, and to direct gas from the three other bellows away from the ion source 300. The change over valve 500 may be configured to switch between bellows 610, 620, 630 and 640 such that gas from any one of the bellows 610, 620, 630 and 640 may be directed towards the ion source 300 at any one time. Multiple inlet IRMS allows a plurality of gases to be measured and compared against one another. For example, a first gas may be measured and compared against a second gas, and the first gas may be measured and compared against a third gas. The term multiple inlet may refer to any number of inlets more than one, for example, two, three, four, five, six, etc. The most common arrangement may involve two inlets (Dual Inlets). For simplicity of explanation, the embodiments in the present disclosure are Dual Inlet embodiments. However, the concepts described may be equally applicable to multiple inlet apparatus comprising more than two inlets.

In Dual Inlet IRMS, the measured isotope ratio of a sample gas is compared against the measured isotope ratio for a standard or reference gas. In the arrangement shown in FIG. 1, the first gas in the first bellows 110 may comprise a standard or reference gas and the second gas in the second bellows 210 may comprise a sample gas or vice versa.

Gas flow through the capillaries from the first bellows 110 to the ion source 300 is achieved by a pressure difference between the first bellows 110 and the ion source 300. A first crimp 140 may be located on the thin capillary between the first bellows 110 and the ion source 300. The first crimp 140 provides a strong compression on the source facing end of the capillaries that limits the flow of the first gas. The crimp may be adjusted to control the depletion rate of the gas.

Gas flow through the capillaries from the second bellows 210 to the ion source 300 is achieved by a pressure difference between the second bellows 210 and the ion source 300. A second crimp 240 may be located on the thin capillary between the second bellows 210 and the ion source 300. The second crimp 240 provides a strong compression on the source facing end of the capillaries that limits the flow of the second gas. The crimp may be adjusted to control the depletion rate of the gas

Gas flow into the first and second bellows 110 and 210 may be high pressure, and under laminar flow conditions. Gas flow from the first and second bellows 110 and 210 towards the ion source 300 and vacuum 400 may be under molecular flow conditions. Due to molecular flow and a short mean free path, isotope fractionation may not exist (within detection limits) between the bellows 110 and 210 and the ion source 300. The laminar flow may allow back diffusion and mixing of the gas, which also contributes to avoiding isotope fractionation.

Adjusting the compression of the first bellows 110 allows the pressure inside the first bellows 110 to be increased or decreased. This results in an increase or decrease of the gas flow into the ion source 300. An increase or decrease in pressure leads to an increase or decrease, respectively, in the intensity of the signal (or beam intensity) detected by the IRMS. The intensity of the signal should be kept within a working range of the IRMS, such that it is below an amplifier saturation and above the shot-noise limit. The intensity may be kept below a limit for protection of the ion source filament, since the filament may be pressure sensitive. In particular, non-inert gases at high pressure may damage the ion source filament. The equivalent applies to the second bellows 210.

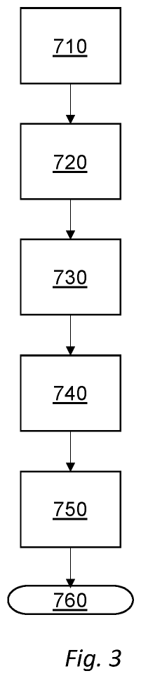

With reference to FIG. 3, a method of operating a Dual Inlet apparatus (such as that shown in FIG. 1) for an isotope ratio mass spectrometer according to an embodiment of the present disclosure is as follows. At step 710, the compression of the first bellows 110 is adjusted to a first compression value such that a first pressure of the first gas is equal to a target pressure value. At step 720, the compression of the second bellows 210 is adjusted to a second compression value such that a second pressure of the second gas is equal to the target pressure value. The target pressure value may be the same for the first gas and the second gas. At step 730, a compression function is determined. The compression function may be based at least one of one or more depletion curves of the bellows (which may be dependent on an initial pressure in the bellows, discussed later in the description), a calibration of the Dual Inlet apparatus, and starting conditions (such as an initial pressure of the gas in the bellows, an initial beam intensity, an initial bellows compression, and an initial decay of beam intensity immediately before the measurement). The calibration of the Dual Inlet apparatus may comprise a calibration of the positions of the bellows, or the speed of the apparatus (for example angle per second, metric distance per second or electric current, or any parameter which defines the speed or movement of the apparatus to change the length of the bellows). The initial decay of beam intensity may be used for a mathematical learning function during measurement, and compression factor quality control. The compression function is configured to maintain the first pressure and the second pressure at the target pressure value, such that when the first bellows 110 or second bellows 210 are compressed according to the compression function, the pressure of the first gas and the pressure of the second gas is constant during the compression. At step 740, the first bellows 110 are continuously compressed according to the compression function. This causes gas flow of the first gas from the first bellows 110 to the ion source 300, and a first measurement of first isotope ratios for the first gas is carried out. The first bellows 110 are continuously compressed according to the compression function until the first measurement is complete or the first bellows 110 are fully compressed. At step 750, the second bellows 210 are continuously compressed according to the compression function. This causes gas flow of the second gas from the second bellows 210 to the ion source 300, and a second measurement of second isotope ratios for the second gas is carried out. The second bellows 210 are continuously compressed according to the compression function until the second measurement is complete or the second bellows are fully compressed, and the method terminates at step 760. Steps 740 and 750 may occur simultaneously, such that compression of the first and second bellows 110 and 220 is not interrupted. During step 740, the first gas may be directed from the first bellows 110 to the ion source 300, and the second gas may be directed from the second bellows 220 to the vacuum 400. During step 750, the first gas may be directed from the first bellows 110 to the vacuum 400, and the second gas may be directed from the second bellows 220 to the ion source 300.

In an embodiment, the first gas may be measured until the intensity of the signal reaches the noise limit. Alternatively, the measurement may stop before the noise limit is reached. In an embodiment, the method may further comprise measuring the first gas again after measuring the second gas. The second measurement of the first gas may start without adjusting the pressure (in other words the first bellows continues to be compressed according to the compression function, without any adjustment), or step 710 may be repeated. In the event that step 710 is repeated, this may compensate for instrument drift.

Measurements of the first and second gases may be repeated. Short integration times are possible using this method, and so a plurality of measurements of the first and second gases may be carried out, with relatively short measurement times. This allows full correction for instrument drift. Measurements of the first and second gas may alternate (for example first gas, second gas, first gas, second gas, . . . ), or may follow a different sequence (for example, the first gas may be measured more than once without measuring the second gas in between measurements of the first gas).

In an embodiment, the target pressure value may be determined based on an analytical range of the detector or on the pressure of the other bellows. In an embodiment, the target pressure value may be defined based on the pressure of gas passing into the first and second bellows 110 and 210, for example the pressure of gas through the first and second bellows inlet valves 120 and 220. In an embodiment there may be communication between first and second bellows inlet valves 120 and 220 to achieve the same pressure in the first and second bellows 110 and 210. In an embodiment, the target pressure value may be defined by software, or pre-determined.

Steps 710 and 720 comprise adjusting the pressure of the first gas in the first bellows 110 and the pressure of the second gas in the second bellows 210 to be the same target pressure value. Matching the pressures in this way assists accuracy in Dual Inlet measurements, since for accurate measurements it is preferable to match the beam intensity for the first gas and the second gas. The beam intensity depends on the gas flow into the ion source 300, and that in turn is dependent on the pressure in the bellows 110, 210. Achieving equal gas flows of the first gas and second gas may be further achieved by adjusting the capillary crimping (at 140 and 240).

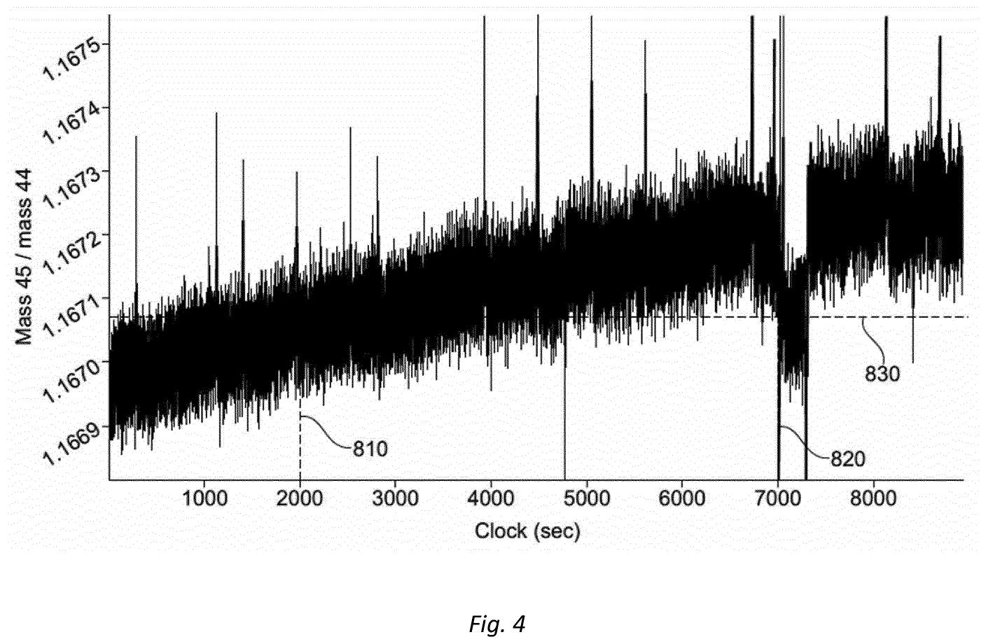

The compression of the bellows 110, 210 carried out at steps 740 and 750 is not interrupted, since any interruption may result in a change to the gas flow conditions and hence a fluctuation in the observed isotope ratio. The fluctuation may be a result of physical fractionation or of non-linearity with fluctuations of beam intensity. Instead, continuous compression of the bellows 110, 210 allows constant pressure of the gas in the bellows 110, 210 and a constant gas flow into the ion source 300. Thus, a constant beam intensity is achieved that is independent of the actual compression of the bellows 110, 210. Maintaining a constant pressure thereby excludes non-linearity of the measurements. FIG. 4 illustrates a test carried out to show that the isotope ratio is independent of the actual compression of the bellows 110, 210, and is solely dependent on the pressure of the gas in the bellows 110, 210. FIG. 4 shows the measured ratio of the beam intensity signals on masses 45 and 44 plotted against time in seconds for CO₂. At 7000 seconds (dashed line 820), the pressure was briefly readjusted to correspond to the value obtained (dashed line 830) at 2000 seconds (dashed line 810) by adjusting bellows compression. The measured isotope ratio was the same at both times, despite different bellows compressions, and so the measured isotope ratio is solely dependent on the CO₂ pressure, as expected.

In an embodiment, in the event that the compression ratio is measured and a significant change in pressure (above a threshold change) is identified, the compression function (i.e. the speed of the compression apparatus) may be altered during compression.

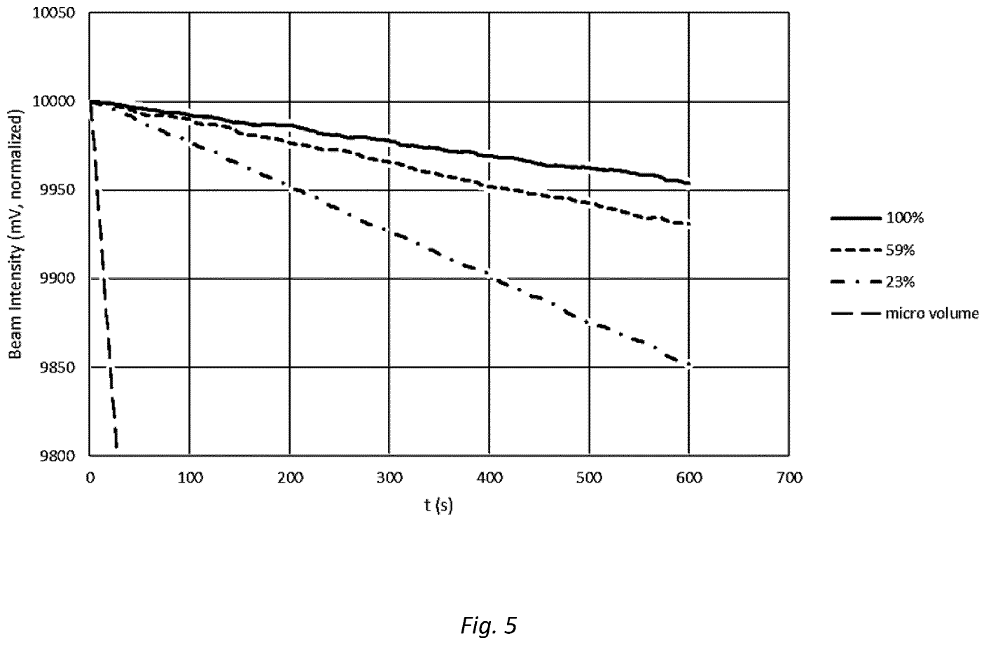

With reference to FIG. 5, conventional Dual Inlet measurements keep the bellows compression constant during a measurement and so the pressure of the gas decreases over time and the beam intensity decays over time. Decay of beam intensity over time is more pronounced at a given pressure if the bellows are more compressed, meaning that matching the decay of beam intensities for two gases is different for bellows that are more compressed.

FIG. 5 shows the decay of beam intensity over time for a bellows with a 40 mL volume at three different positions (100%, 59% and 23% where 100% corresponds to the bellows being fully open). The bellows are held at constant compression during the measurement to illustrate the decay of beam intensity. In each case, the pressure of the gas in the bellows (CO₂ in this example) is the same in the initial phase (at time zero) but will change due to flow of gas to the ion source 300. The graph plots normalized beam intensity in mV against time t in seconds. The fourth line on the graph is the beam intensity for a fixed volume 50 μL microvolume. FIG. 5 shows that the decay of the beam intensity is slowest for the open bellows (100%) and fastest for the most compressed bellows (23%) despite the pressure in each bellows being the same at the start of the measurement. At higher compression with the same pressure, the rate of evacuation is faster because the volume is smaller. In other words, more molecules flow through an orifice at a higher compression. In practice, it is common in conventional measurements to carry out measurements with bellows open between 70% and 100%, allowing for easier matching of beam intensity decay for two gases.

Rather than keeping bellows compression constant as in conventional measurements, steps 740 and 750 continuously compress the first bellows 110 and second bellows 210 according to the compression function and thereby eliminate decay of beam intensities. In an embodiment, in the event that the beam intensity cannot be kept exactly constant, for example due to limited precision of a calibration, the drop in beam intensity may be partially compensated by applying a compression rate slightly smaller than calculated. As indicated by the results in FIG. 5, reducing the compression rate will reduce the rate at which the beam intensity decreases and so will reduce the impact of non-linearity.

In a further embodiment, the observed beam intensity may be monitored during the measurements and in the event that a significant change in beam intensity is observed, the compression rate may be adjusted. Care must be taken in altering the compression function, since any sudden change in gas flow rate towards the ion source 300 may introduce non-linearity and a risk of fractionation.

In an embodiment, the first and second bellows 110, 210 may be compressed simultaneously each according to a compression function. The measurement may then switch between the first gas and the second gas by using the changeover valves to direct the first and second gases towards the ion source 300 or the vacuum 400.

In an alternative embodiment, during step 740 (in which the first bellows 110 are continuously compressed according to the compression function) the second bellows 210 may be held at constant compression. During step 750 (in which the second bellows 210 are continuously compressed according to the compression function) the first bellows 110 may be held at constant compression.

In an alternative embodiment, the multiple inlet apparatus may further comprise a first bellows valve configured to close the first bellows and a second bellows valve configured to close the second bellows. During step 740 (in which the first bellows 110 are continuously compressed according to the compression function) the second gas may be enclosed within the second bellows by the second. During step 750 (in which the second bellows 210 are continuously compressed according to the compression function) the first gas may be enclosed within the first bellows by the first bellows valve. In other words, while the first bellows is being compressed in order to direct the first gas from the first bellows to the ion source, the second bellows is held closed and the second gas is prevented from leaving the second bellows. While the second bellows is being compressed in order to direct the second gas from the second bellows to the ion source, the first bellows is held closed and the first gas is prevented from leaving the first bellows.

The decay of beam intensity during conventional measurements may limit the utilization of a sample, since eventually the beam intensity decays sufficiently that it approaches the shot noise limit at which electronic noise exceeds real signal. Maintaining constant beam intensity helps to avoid this issue.

Compression of the bellows 110, 210 may be carried out using an apparatus such as a motor using a gear drive, a linear actuator or a stepper motor. A small step size, or zero step size, is desirable since any sudden change in gas pressure may cause turbulence in the gas flow and therefore spikes in the measured isotope ratio. A motor comprising a stepper motor may be preferable. The velocity of the motor is a function of only stepping frequency, which can be precisely tuned. Furthermore when the holding current is applied to the stepper motor, the bellows position is not altered even if force is applied to the bellows (for example by the vacuum inside the bellows). A stepper motor may overcome an issue found in other motors whereby the starting current causes the motor to overshoot initially. A digitally controlled stepper motor will keep the motor on hold and will avoid “overshooting” by the motor controller.

Prior to measurements, the Dual Inlet apparatus requires careful calibration of the position of the bellows to allow definition of a compression function. The compression function may then be calculated based on start conditions for the Dual Inlet apparatus, such as depletion rate, compression of the bellows 110, 210, gas pressure and initial beam intensity.

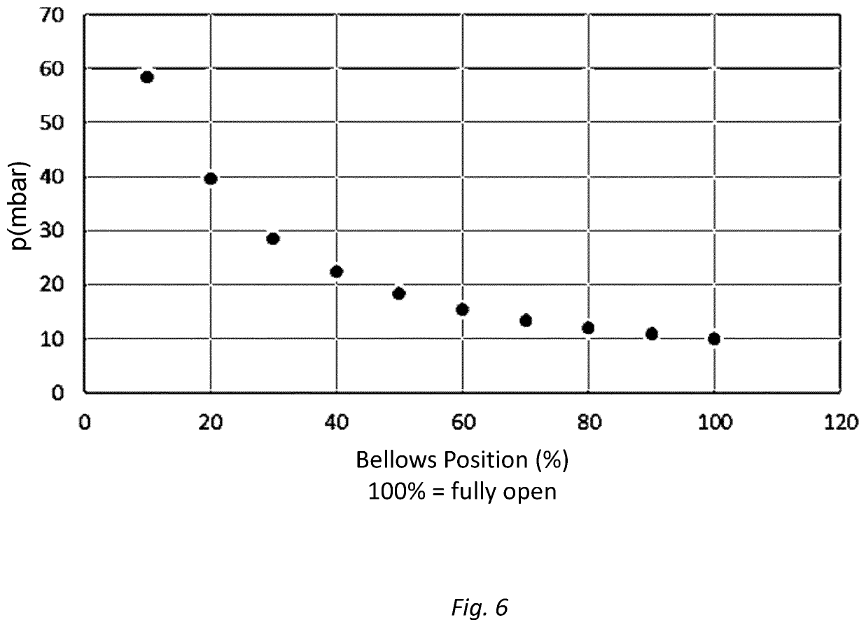

Referring back to FIG. 1, the gas from the bellows (110 or 210) flows through a crimped capillary (crimped at 140 or 240) into the ion source 300. The crimp reduces the gas flow rate down to the molecular flow region. The crimp may be described as an orifice with a transmission coefficient K, and the gas flow from the bellows 110, 210 may be described as:

$$v = - \frac{dn ( t )}{dt} = p ( t ) \cdot K$$

where n is the amount of gas molecules (in number of moles) and p is the pressure inside the bellows. For a given amount n of gas molecules, the pressure in the bellows is inversely proportional to its volume V (following trivially from the universal gas equation p·V=n·R·T where R is the universal gas constant and T is temperature). However, due to the mechanical construction of the bellows the volume of the bellows, and hence the pressure of the gas in the bellows, is not proportional to the compression. In other words, a constant rate of compression does not result in a constant pressure of gas in the bellows. This behaviour is shown in FIG. 6, in which pressure is plotted against bellows position (100% being fully open). The compression function needs to take this into account; in order to hold the pressure constant, the compression rate needs to be reduced over time.

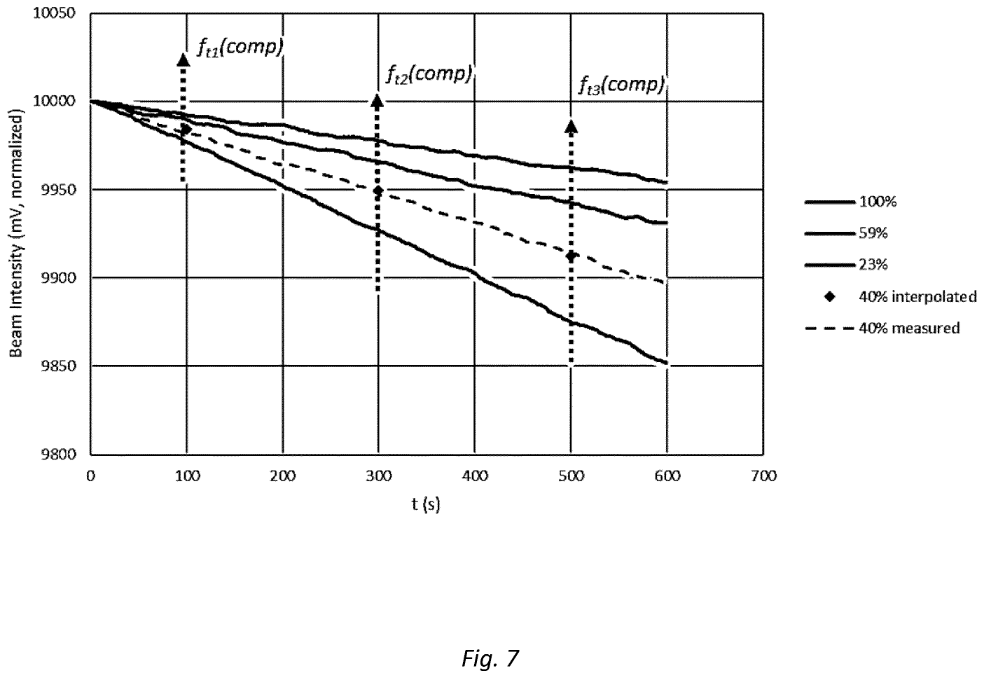

The calibration of the Dual Inlet apparatus utilizes the fact that the gas flow into the ion source 300 is proportional to the gas pressure inside the bellows 110, 210. The rate at which the bellows 110, 210 deplete is dependent on the starting pressure or starting beam intensity, and the compression or size of the bellows 110, 210. After calibration of the system, the depletion of the bellows 110, 210 may be extrapolated from these start conditions. Knowledge of the pressure increase with bellows compression allows definition of a compression function to counteract the depletion. Thus, two calibrations are required to define a compression function: a calibration of depletion of the bellows 110, 210 versus the starting parameters (for example depletion rate, compression of the bellows 110, 210, gas pressure and initial beam intensity), and a calibration of pressure or beam intensity versus bellows compression. A calibration of pressure versus bellows compression may be achieved via known techniques, but the calibration of depletion versus the starting parameters is described in the following. This calibration may be carried out separately for the first bellows 110 and the second bellows 210 and may be different for different gases. A set of l≥3 calibration depletion curves is obtained. The bellows 110, 210 being calibrated are filled with different amounts of gas for each calibration depletion curve, but the pressure is adjusted to roughly the same value for each calibration depletion curve and so each calibration depletion curve is obtained with different bellows compressions. The decrease in beam intensity over time is recorded. An example may be seen in FIG. 7. The solid lines are calibration depletion curves measured at 100%, 59% and 23% bellows positions (where 100% is fully open). At a given time t the relationship fₜ(comp) between beam intensity and bellows compression may be determined from the beam intensity at time t for each calibration depletion curve. This is indicated on FIG. 7 by dashed arrows at 100, 300 and 500 seconds. The relationships fₜ(comp) may be used to interpolate depletion curves for other bellows compressions. This is indicated in FIG. 7, where the diamonds show the points that are interpolated for a bellows position of 40% open. The dashed line shows the measured depletion curve for a bellows position of 40%, for comparison. As may be seen in FIG. 7, the interpolated points accurately agree with the measured depletion curve.

The beam intensity may change over time due to changes of an analyser counting rate. The starting compression (or pressure) of a measurement may need to be adjusted, but the compression function may not require recalculation. In the event that the counting rate improves (i.e. the sensitivity of the analyser improves), the signal to pressure ratio may decrease and the depletion curve for bellows being 100% open may need to be re-measured.

Before a measurement, the bellows 110, 210 are compressed until the beam intensity is the same as for the calibration. The compression achieved is then used to interpolate a depletion curve. A calibration of pressure or beam intensity with compression may then be used determine measures to counteract the depletion.

For example, a measurement may begin with a bellows position of 40% open. Using the interpolated depletion curve, it may be calculated, that a further compression to 39.8% is required within the first second of the measurement to counteract depletion. Next, the respecting depletion curve for bellows position of 39.8% open is used to calculate the required compression for the next time interval, and so on.

The relationships fₜ(comp) may comprise power functions. The power functions may be of the form beam intensity at x %=(beam intensity at 100%)·(x^{a}) where x is the compression and a is a fit parameter determined from the calibration depletion curves.

In an embodiment, instead of using the initial beam intensity and bellows calibration to determine a depletion curve, the decay of the beam intensity or pressure during a short time period (such as 60 seconds) immediately before the beginning of the measurement may be used to identify the depletion curve.

In an embodiment, a single calibration for all bellows may be sufficient and may be used for all other bellows. This may allow quicker, but possibly less precise, measurements. A compression function may be obtained for only one bellow and applied to all bellows. This may be most effective (may result in a smaller loss of precision) when properties of the bellows and capillaries are similar, for example bellow volume, capillary dimensions and crimping.

Compression functions may be based on a target pressure value for the bellows and may be influenced by properties of the capillaries, a compression device, the bellows volume, and the analyser sensitivity.

The compression function may comprise a plurality of compression positions corresponding to a plurality of time-points.

In an embodiment, calibration of a pressure meter may be defined and checked. Calibration of pressure functions and signal intensity may be defined and checked. The signal intensity may be related to sensitivity of the spectrometer, and may need to be adjusted to the pressure function for a given bellow position.

1.-35. (canceled)

36. A method of operating a multiple inlet apparatus for an isotope ratio spectrometer, the multiple inlet apparatus having a first bellows containing a first gas and a second bellows containing a second gas and the method comprising:
adjusting compression of the first bellows to a first compression value such that a first pressure of the first gas is equal to a target pressure value;
adjusting compression of the second bellows to a second compression value such that a second pressure of the second gas is equal to the target pressure value;
determining a first compression function configured to maintain the first pressure at the target pressure value and a second compression function configured to maintain the second pressure at the target pressure value;
continuously compressing the first bellows according to the first compression function until a first measurement of first isotope ratios for the first gas is complete; and
continuously compressing the second bellows according to the second compression function until a second measurement of second isotope ratios for the second gas is complete.

37. The method of claim 36 further comprising compressing the first bellows according to the compression function until a third measurement of third isotope ratios for the first gas is complete, wherein the third measurement takes place after the second measurement.

38. The method of claim 36 wherein measurements of the first gas and the second gas alternate such that the first gas and the second gas are each measured at least twice.

39. The method of claim 36 wherein the steps of continuously compressing the first bellows and continuously compressing the second bellows occur simultaneously.

40. The method of claim 39, the multiple inlet apparatus comprising at least one valve that directs the first gas and the second gas towards either an ion source or a vacuum.

41. The method of claim 40 wherein during the first measurement the first gas is directed from the first bellows to the ion source and the second gas is directed from the second bellows to the vacuum, and wherein during the second measurement the first gas is directed from the first bellows to the vacuum and the second gas is directed from the second bellows to the ion source, wherein optionally:
the method further comprises at least one further measurement of the first gas, wherein the first gas is directed from the first bellows to the ion source and the second gas is directed from the second bellows to the vacuum.

42. The method of claim 36 wherein the first bellows and the second bellows are compressed using stepper motors.

43. The method of claim 36, wherein the first gas and/or second gas comprises a first gas mixture and a second gas mixture, respectively.

44. The method of claim 36, wherein either:
the target pressure is equal to a first filling pressure of the first bellows or a second filling pressure of the second bellows; or
the target pressure is independent of a first filling pressure of the first bellows and a second filling pressure of the second bellows.

45. The method of claim 36 wherein the first compression function and second compression function comprise an initial compression based on a starting signal intensity of the spectrometer.

46. The method of claim 36 wherein the first compression function and the second compression function are the same.

47. The method of claim 36 wherein more than one isotope ratio of the first gas are measured using the same first compression function.

48. The method of claim 36 wherein the first compression function and second compression function are determined during compression of the first bellows and second bellows respectively, either:
by measuring the first pressure and the second pressure, wherein optionally a pressure transducer is used to measure the first pressure and the second pressure; or
by measuring pressure in an ion source; or
by measuring the gas flow into the ion source.

49. The method of claim 36 wherein:
the first bellows is connected to an ion source via a first inlet; and
the second bellows is connected to the ion source via a second inlet.

50. The method of claim 36, the multiple inlet apparatus further comprising at least one additional bellows for at least one additional gas, wherein optionally the at least one additional bellows is connected to an ion source via at least one additional inlet.

51. The method of claim 36 wherein the multiple inlet apparatus further comprises a first bellows valve configured to close the first bellows and a second bellows valve configured to close the second bellows, wherein:
during the first measurement the first gas is directed from the first bellows to an ion source and the second gas is enclosed within the second bellows by the second bellows valve; and
during the second measurement the second gas is directed from the second bellows to the ion source and the first gas is enclosed within the first bellows by the first bellows valve.

52. Software for operating a multiple inlet apparatus for an isotope ratio spectrometer, wherein the software is configured to carry out the method of claim 36.

53. A multiple inlet apparatus for an isotope ratio mass spectrometer, configured to be operated via the method of claim 36.

54. A multiple inlet apparatus for an isotope ratio mass spectrometer comprising a controller configured to carry out the method of claim 36.

55. An isotope ratio mass spectrometer comprising the multiple inlet apparatus of claim 54.
